(19) United States
(12) Patent Application Publication
(10) Pub. No.: US 2023/0402618 A1
(43) Pub. Date: Dec. 14, 2023

(54) METHOD FOR SYNTHESIS OF POROUS MONOLITHS OF TRANSITION-METAL-DOPED-NOBLE-METAL

(71) Applicant: LOG 9 MATERIALS SCIENTIFIC PRIVATE LIMITED, Bangalore (IN)

(72) Inventors: KIRANPAL SINGH, Bengaluru (IN); YASH RAJESH BHAT, Koppal (IN); HEMANT CHARAYA, Jalgaon (IN); VIJAY RAMAN CHAUDHARI, Jalgaon (IN)

(21) Appl. No.: 18/250,976

(22) PCT Filed: Oct. 27, 2021
(86) PCT No.: PCT/IN2021/051025

§ 371 Date: Apr. 27, 2023

(30) Foreign Application Priority Data
Oct. 27, 2020 (IN) 202041046813

(51) Int. Cl. H01M 4/90

(52) U.S. Cl. CPC H01M 4/9041

(57) ABSTRACT

The embodiment herein provides a simple, one-pot and scalable methodology for the synthesis of porous monoliths of Transition-metal-doped-noble-metal nanoparticles for cathode catalyst in a metal-air battery, PEMFCs, AFCs, and anode catalyst in water electrolysers. Silver is used as a base material on which doping is done with the transition metals selected from Cu, Co, Mn, Fe, and Ni.

### CROSS-REFERENCE TO RELATED APPLICATIONS

This application is a national stage application of the Patent Cooperation Treaty (PCT) international stage application titled “METHOD FOR SYNTHESIS OF POROUS MONOLITHS OF TRANSITION-METAL-DOPED-NOBLE-METAL”, numbered PCT/IN2021/051025, filed at World Intellectual Property Organization (WIPO) on Oct. 27, 2021. The aforementioned PCT international phase application claims priority to the Indian Provisional Patent Application (PPA) with serial number 202041046813 filed on Oct. 27, 2020, with the title “METHOD FOR SYNTHESIS OF POROUS MONOLITHS OF TRANSITION-METAL-DOPED-NOBLE METAL”. The contents of abovementioned PPA are included in entirety as reference herein.

### BACKGROUND

### Technical Field

The embodiments herein are generally related to the field of fuel cells and metal-air batteries. The embodiments herein are more particularly related to an electrocatalyst that facilitate oxygen reduction reaction at cathode in fuel cells and metal air batteries.

### Description of the Related Art

The oxygen reduction reaction (ORR), occurring at the cathode of a metal-air fuel cell, is significantly important in dictating the overall potential of the cell. However, given the intrinsically stable nature of the Oxygen (O₂) molecule, its reduction at electrochemical usable potential is difficult. Platinum (Pt) based materials have shown promising results in activating the O₂ molecule for ORR in alkaline media. However, given its high price and low Pt/PtO oxidation potential, its applicability in metal-air fuel cells is restricted. Silver (Ag) based materials have gained huge interest as a cathode catalyst in Metal-air fuel cells due to its relatively high activity, nobility, abundance and ˜200 mV higher Ag/Ag₂O potential compared to Pt. However, the performance of Ag is still not comparable with the commercial state-of-the-art carbon supported Pt (Pt/C) catalyst.

The low activity of Ag towards ORR owes to its poor binding with oxygen and its intermediates. Various DFT (Density Functional Theory) simulation studies have found that combining transition metals with Ag can improve the binding strength of Ag with oxygen and its intermediates by uplifting its d-band. Although, facile process to obtain such combination on a practical level is still an elusive task.

Major obstacle in synthesizing Ag-transition metal alloys is that silver and transition metals are immiscible in each other in the bulk phase. Apart from that, huge reduction potential difference between Ag and the transition metals leads to the preferential reduction of Ag ions over transition metal ions during wet chemical synthesis. It has been shown that the issue of immiscibility can be overcome at nanoscale level, as the factor of high surface energy starts to govern the thermodynamic stability of the system at this level. However, the high surface energy also causes these nanoparticles to agglomerate/oxidize and thereby severely impact their catalytic activity in a long run, especially under highly caustic conditions of metal-air fuel cells. Apart from this, transition metals have low oxidation potential because of that they tend to oxidize once the alloy/composite of the Ag-Transition metal is formed, which eventually can reduce the electronic conductivity of the electrocatalyst.

In the backdrop of emerging demand/trend, there is a long felt need to improve the catalytic activity of silver towards ORR where it can perform at par with the standard Pt/C catalyst and thereby turn out to be an economically viable solution to reduce the exorbitant costs of catalyst in metal-air and hydrogen fuel cells. Moreover, there is a need to improve catalytic activity of Ag towards ORR without compromising over its electrical conductivity and stability in harsh conditions.

The abovementioned shortcomings, disadvantages and problems are addressed herein, which will be understood by reading and studying the following specification.

### OBJECTIVES OF THE EMBODIMENTS HEREIN

The primary object of the embodiments herein is to provide a method to prepare electrocatalyst for oxygen reduction reaction (ORR) by combining Silver (Ag) with transition metals.

Another object of the embodiments herein is to provide an electrocatalyst that possess higher catalytic activity towards the ORR in comparison to the one made from virgin silver.

Yet another object of the embodiments herein is to provide a porous transition-metal-doped silver based electrocatalyst material.

Yet another object of the embodiments herein is to provide a method to synthesize transition-metal-doped silver.

Yet another object of the embodiments herein is to provide a methodology to synthesize transition-metal-doped silver where transition metal doping amount can be in the range of 1-7%.

Yet another object of the embodiments herein is to provide a one-pot methodology for the synthesis of Transition-Metal-doped silver.

Yet another object of the embodiments herein is to provide a facile and one-pot methodology for the synthesis of high purity Transition-Metal-doped silver.

Yet another object of the embodiments herein is to provide a facile and one-pot methodology for the synthesis of high purity Transition-Metal-doped silver from wet chemical synthesis.

Yet another object of the embodiments herein is to provide the transition metal in transition-metal-doped silver that can be one out of Cobalt (Co), Copper (Cu), Nickel (Ni), Iron (Fe) and Manganese (Mn) and the like.

Yet another object of the embodiments herein is to provide the reducing agent in the synthesis of the transition-metal-doped silver can be at least one or mixture of Sodium borohydride, Sodium Hydride, Lithium Hydride, Lithium Aluminium Hydride, and Hydrazine Hydroxide and the like.

Yet another object of the embodiments herein is to provide the capping agent used in the synthesis of the transition-metal-doped-noble-metal can be at least one or mixture of 2-mercapto ethanol, 1-thioglycerol, thioglycolic acid, thiolactic acid and sodium citrate and the like.

Yet another object of the embodiments herein is to provide the transition-metal-doped silver material obtained from the one pot synthesis procedure is in the form of a porous monolithic structure.

Yet another object of the embodiments herein is to provide the self-standing-monolith of Transition-Metal-doped silver with a porosity in the range of 10-100 m²/gm.

Yet another object of the embodiments herein is to provide an electrocatalyst for oxygen reduction reaction, wherein the self-standing monolithic structure of transition-metal-doped silver comprises of nanoparticles in the size range of 5-100 nm adjoined together anisotropically.

Yet another object of the embodiments herein is to prepare the self-standing-monolith of Transition-Metal-doped silver via anisotropic growth of the doped metal nanoparticles.

Yet another object of the embodiments herein is to provide that the self-standing monolithic structure of transition-metal-doped silver with significantly lower surface energy than that of individual nanoparticles and thereby that stays more stable under harsh reaction conditions.

Yet another object of the embodiments herein is to provide the self-standing monolithic structure of transition-metal-doped silver comprising significantly lower surface energy than that of individual nanoparticles because of its anisotropic nature.

Yet another object of the embodiments herein is to use the transition metal doping to improve the oxygen adsorption-desorption of the silver during oxygen reduction reaction.

Yet another object of the embodiments herein is to use the transition metal doping to decrease the peroxide formation capacity of the silver during oxygen reduction reaction.

Yet another object of the embodiments herein is to provide the transition-metal-doped-silver electrocatalyst that can be used for application in Oxygen reduction reaction (ORR) in metal-air and hydrogen fuel cells.

Yet another object of the embodiments herein is to provide the transition-metal-doped silver electrocatalyst which exhibits better electro-catalytic activity in comparison to that of the virgin silver electrocatalysts.

Yet another object of the embodiments herein is to provide the one-pot synthesis process that can be scaled up for large scale production without any impact on its catalytic properties.

Yet another object of the embodiments herein is to provide the transition-metal-doped silver electrocatalyst, which owns very good corrosion resistance in harsh reaction conditions.

Yet another object of the embodiments herein is to provide the material that can be used in air cathodes for applications in Metal-air batteries, Fuel cell and water electrolysers.

These and other objects and advantages of the embodiments herein will become readily apparent from the following detailed description taken in conjunction with the accompanying drawings.

### BRIEF SUMMARY OF THE EMBODIMENTS

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a simple, one-pot and scalable methodology for the synthesis of porous monoliths of Transition-metal-doped-silver for cathode catalyst in the metal-air battery, Polymer Electrolyte Membrane Fuel cells (PEMFCs), Alkaline fuel cells (AFCs), and anode catalyst in water electrolysers.

The embodiments herein provides a one-pot method for synthesis of porous monolith of transition-metal doped-silver electrocatalyst for oxygen reduction reaction comprises the steps of: firstly, transition metal salt is added at a concentration of 1-10 mM in to 1000 ml distilled water to form a solution and then the solution is stirred at a speed of 400 RPM at a temperature of 20 to 25° C. Followed by 10 ml solution of capping agent at a concentration of 1-5 mM is added to the obtained solution and the solution is stirred at 400 RPM at a temperature of 20 to 25° C. The capping agent is then added to the solution to stabilize the transition metal salt. Furthermore, Ag water soluble salt is added at a concentration of 1-10 mM to the obtained solution comprising transition metal salt and capping agent, and stirring the resultant solution at 400 RPM at a temperature of 20 to 25° C. Besides, 10 ml solution of reducing agent at a concentration of 0-150 mM is added to the obtained Ag water soluble salt solution and the solution is stirred at a speed of 400 RPM at a temperature of 20 to 25° C. to form a porous monolith Ag nanoparticle. The porous monolith Ag nanoparticles formed are then filtered and the resultant porous monolith Ag nanoparticles are dried in vacuum at 50° to 100° C.

According to one embodiment herein, the capping agent used for the synthesis of porous monolith of transition-metal doped-silver electrocatalyst involving oxygen reduction reaction includes 2-mercapto ethanol, 1-thioglycerol, thioglycolic acid, thiolactic acid, sodium citrate or their mixture thereof. The capping agents are shape directing agents, which can manipulate the size and shape of the nanoparticles at submicron level. The capping agent also helps to stabilize the formed cations by capping them and ensures homogeneous dispersion of metal cations in the solution, which upon reduction will give homogeneously dispersed metal nanoparticles. Furthermore, the capping agent increases the repulsion force between the nanoparticles and hence decreases the nanoparticle agglomeration. The capping agent also helps to form a stable bond with the transition metal ions, due to which transition metal ion reduction gets inhibited and thereby accelerates the doping phenomenon.

According to one embodiment herein, the Ag water soluble salt is selected from the group consisting of silver nitrate, silver fluoride, silver acetate, silver sulfate, silver nitrite and the like. The Ag water soluble salt acts as the precursor for the Ag matrix.

According to one embodiment herein, the reducing agent is selected from the group consisting of Sodium borohydride, Sodium Hydride, Lithium Hydride, Lithium Aluminium Hydride, Hydrazine Hydroxide or their mixture thereof. To obtain the porous structure of monolith Ag nanoparticles, fast addition of the reducing agent is employed at 100 ml/min. Fast addition will increase the metal seed concentration and capping agent will ensure to keep these seeds separated from each other, by increasing the repulsive. Hence, this not only enables the formation of metal seeds but also increase the ionic strength of the solution, leading to the anisotropic mingling of formed metal nanoparticles and yield the porous Ag nanoparticles monolith. Apart from this, presence of highly active Ag metal seeds and a strong reducing agent will weakly induce reducing effect on the highly stable transition metal and capping agent complex and carry out the doping of the said transition-metal in the Ag seed before its anisotropic agglomeration. Therefore, the one-pot synthetic protocol can be used to synthesize range of high purity and porous doped-noble metals. Furthermore, addition of reducing agent will increase the ionic strength of the solution which will cause the anisotropic aggregation of nanoparticles, leading to salting out of the formed nanoparticles in the form of porous monoliths.

According to one embodiment herein, the synthesized transition-metal-doped-Ag nanoparticles monoliths are porous and their porosity ranging from 10-100 m²/gm. The obtained materials have nanoparticles in the size range of 5-100 nm. Furthermore, the porous monolith Ag nanoparticles are configured in a circlet manner and adjoined together anisotropically. The circlet configuration and anisotropic nature of the porous monolith Ag nanoparticles provides significantly lower surface energy and higher stability than that of individual Ag nanoparticles. In addition, normal Ag nanoparticles possess very high surface energy due to which during metal air battery operation, the virgin Ag nanoparticles agglomerate randomly to reduce their surface energy, which causes lower life cycle of the electrocatalyst. However, the porous monolith Ag nanoparticles are connected to each other in a “circlet” configuration, and hence the surface energy is quite less in the porous monolith Ag nanoparticles, as two facets of the nanoparticles are connected to other nanoparticles. Hence the circlet configuration gives very high stability to the porous monolith Ag nanoparticles in comparison to the virgin Ag nanoparticles.

According to one embodiment herein, a porous monolith of transition-metal doped silver electrocatalyst for oxygen reduction reaction (ORR) comprising silver (Ag) nanoparticles doped with transition metals to uplift the d-band center of silver (Ag) nanoparticles and to improve catalytic activity of silver nanoparticles towards oxygen reduction reaction. Low d-band centre of Ag (−5.28 eV) has been thought to be the primary reason for its tendency to bind O₂ and its intermediates weakly and hence delivering low ORR kinetics. Therefore, mixing transition metals to the Ag lattice has shown to improve the binding of O₂ and its intermediates, hence leading to better ORR activity.

According to one embodiment herein, the silver nanoparticles (Ag) is used as the base material doped with transition metal. The silver nanoparticles (Ag) is used as a base material due to high corrosion resistance, low cost and high catalytic activity towards oxygen reduction reaction (ORR). The transition metals is selected from the group consisting of Cobalt (Co), Copper (Cu), Nickel (Ni), Iron (Fe) and Manganese (Mn). Furthermore, the amount of transition metal doped into the silver (Ag) nanoparticle is the range of 1-7%. The size of porous monolith of transition-metal doped silver electrocatalyst is in the range of 5-100 nm and porosity of porous monolith of transition-metal doped silver electrocatalyst is in the range of 10-100 m²/gm. Furthermore, the porous monolith of transition-metal doped silver electrocatalyst is obtained by anisotropic growth of doped transition metal on silver (Ag) base material. Besides, the transition metal doping into the Ag nanoparticle is said to improve oxygen adsorption-desorption and decrease the peroxide formation capacity of the silver during oxygen reduction reaction. Furthermore, the doping of transition metal on silver (Ag) nanoparticles is carried out without utilizing high temperature or energy intensive process.

According to one embodiment herein, the porous monolith of transition-metal doped silver electrocatalyst finds application as cathode catalyst in metal-air battery, Polymer Electrolyte Membrane Fuel cells (PEMFCs), Alkaline fuel cells (AFCs), and anode catalyst in water electrolysers.

According to one embodiment herein, the synthesis of porous monoliths of transition-metal-doped-noble-metal is one pot, easily scalable and obtained products are of high purity. Furthermore, transition-metal-doped silver electrocatalyst can be used for application in Oxygen reduction reaction (ORR). The transition-metal-doped-silver electrocatalyst also exhibits better electro-catalytic activity in comparison to the virgin electrocatalysts. Moreover, the transition-metal-doped-silver electrocatalyst shows very good corrosion resistance in harsh electrochemical reaction conditions and therefore, the transition-metal-doped-silver electrocatalyst material can be used as air cathodes for applications in metal-air batteries, fuel cell and anodes for water electrolysers.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates an exemplary flow chart on one-pot method for synthesis of AgMn porous monoliths, according to an embodiment herein.

FIG. 2a and FIG. 2b together illustrates an exemplary Scanning electron microscope images of the porous monoliths of transition-metal-doped-noble-metal, according to an embodiment herein.

FIG. 3 illustrates a graph of X-Ray Diffraction analysis and its Rietveld refinement for AgMn porous monoliths, according to an embodiment herein.

FIG. 4 illustrates a graphical representation of an (X-ray photoelectron spectroscopy) peak survey for AgMn porous monoliths, according to an embodiment herein.

FIG. 5 illustrates a tabular representation of anatomic composition derived from X-Ray Photoelectron Spectroscopy for AgMn porous monoliths, according to an embodiment herein.

FIG. 6 illustrates a graphical representation of an Oxygen reduction reaction (ORR) performance of the Ag porous monolith, AgMn porous monoliths and commercial 25% Platinum loaded carbon (Pt/C) catalyst, according to an embodiment herein.

FIG. 7 illustrates the 220 hrs continues cycling test of the cathodes made up of the AgMn porous monoliths electrocatalyst, according to an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provides a simple, one-pot and scalable methodology for the synthesis of porous monoliths of Transition-metal-doped-silver electrocatalyst for cathode in the metal-air battery, Polymer Electrolyte Membrane Fuel cells (PEMFCs), Alkaline fuel cells (AFCs), and anode catalyst in water electrolysers.

The embodiments herein provides a one-pot method for synthesis of porous monolith of transition-metal doped-silver electrocatalyst for oxygen reduction reaction comprises the steps of: firstly, transition metal salt is added at a concentration of 1-10 mM in to 1000 ml distilled water to form a solution and then the solution is stirred at a speed of 400 RPM at a temperature of 20 to 25° C. Followed by 10 ml solution of capping agent at a concentration of 1-5 mM is added to the obtained solution and the solution is stirred at 400 RPM at a temperature of 20 to 25° C. The capping agent is then added to the solution to stabilize the transition metal salt. Furthermore, Ag water soluble salt is added at a concentration of 1-10 mM to the obtained solution comprising transition metal salt and capping agent, and stirring the resultant solution at 400 RPM at a temperature of 20 to 25° C. Besides, 10 ml solution of reducing agent at a concentration of 0-150 mM is added to the obtained Ag water soluble salt solution and the solution is stirred at a speed of 400 RPM at a temperature of 20 to 25° C. to form a porous monolith Ag nanoparticle. The porous monolith Ag nanoparticles formed are then filtered and the resultant porous monolith Ag nanoparticles are dried in vacuum at 50° to 100° C.

According to one embodiment herein, the capping agent used for the synthesis of porous monolith of transition-metal doped-silver electrocatalyst involving oxygen reduction reaction includes 2-mercapto ethanol, 1-thioglycerol, thioglycolic acid, thiolactic acid, sodium citrate or their mixture thereof. The capping agents are shape directing agents, which can manipulate the size and shape of the nanoparticles at submicron level. The capping agent also helps to stabilize the formed cations by capping them and ensures homogeneous dispersion of metal cations in the solution, which upon reduction will give homogeneously dispersed metal nanoparticles. Furthermore, the capping agent increases the repulsion force between the nanoparticles and hence decreases the nanoparticle agglomeration. The capping agent also helps to form a stable bond with the transition metal ions, due to which transition metal ion reduction to metallic state gets inhibited and thereby accelerates the doping phenomenon.

According to one embodiment herein, the Ag water soluble salt is selected from the group consisting of silver nitrate, silver fluoride, silver acetate, silver sulfate, silver nitrite and the like. The Ag water soluble salt acts as the precursor for the Ag matrix.

According to one embodiment herein, the reducing agent is selected from the group consisting of Sodium borohydride, Sodium Hydride, Lithium Hydride, Lithium Aluminium Hydride, Hydrazine Hydroxide or their mixture thereof. To obtain the porous structure of monolith Ag nanoparticles, fast addition of the reducing agent is employed at 100 ml/min. Fast addition will increase the metal seed concentration and capping agent will ensure to keep these seeds separated from each other, by increasing the repulsive. Hence, this will not only enable the formation of metal seeds but will also increase the ionic strength of the solution, leading to the anisotropic mingling of formed metal nanoparticles and yield the porous Ag nanoparticles monolith. Apart from this, presence of highly active Ag metal seeds and a strong reducing agent will weakly induce reducing effect on the highly stable transition metal and capping agent complex and carry out the doping of the said transition-metal in the Ag seed before its anisotropic agglomeration. Therefore, the one-pot synthetic protocol can be used to synthesize range of high purity and porous doped-noble metals. Furthermore, addition of reducing agent will increase the ionic strength of the solution which will cause the anisotropic aggregation of nanoparticles, leading to salting out of the formed nanoparticles in the form of porous monoliths.

According to one embodiment herein, the synthesized transition-metal-doped-Ag nanoparticles monoliths are porous and their porosity ranging from 10-100 m²/gm. The obtained materials have nanoparticles in the size range of 5-100 nm. Furthermore, the porous monolith Ag nanoparticles are configured in a circlet manner and adjoined together anisotropically. The circlet configuration and anisotropic nature of the porous monolith Ag nanoparticles provides significantly lower surface energy and higher stability than that of individual Ag nanoparticles. In addition, normal Ag nanoparticles possess very high surface energy due to which during metal air battery operation, the virgin Ag nanoparticles agglomerate randomly to reduce their surface energy, which causes lower life cycle of the electrocatalyst. However, the porous monolith Ag nanoparticles are connected to each other in a “circlet” configuration, and hence the surface energy is quite less in the porous monolith Ag nanoparticles, as two facets of the nanoparticles are connected to other nanoparticles. Hence the circlet configuration gives very high stability to the porous monolith Ag nanoparticles in comparison to the virgin Ag nanoparticles.

According to one embodiment herein, a porous monolith of transition-metal doped silver electrocatalyst for oxygen reduction reaction (ORR) comprising silver (Ag) nanoparticles doped with transition metals to uplift the d-band center of silver (Ag) nanoparticles and to improve catalytic activity of silver nanoparticles towards oxygen reduction reaction. Low d-band centre of Ag (−5.28 eV) has been thought to be the primary reason for its tendency to bind O₂ and its intermediates weakly and hence delivering low ORR kinetics. Therefore, mixing transition metals to the Ag lattice has shown to improve the binding of O₂ and its intermediates, hence leading to better ORR activity.

According to one embodiment herein, the silver nanoparticles (Ag) is used as the base material doped with transition metal. The silver nanoparticles (Ag) is used as a base material due to high corrosion resistance, low cost and high catalytic activity towards oxygen reduction reaction (ORR). The transition metals is selected from the group consisting of Cobalt (Co), Copper (Cu), Nickel (Ni), Iron (Fe) and Manganese (Mn). Furthermore, the amount of transition metal doped into the silver (Ag) nanoparticle is the range of 1-7%. The size of porous monolith of transition-metal doped silver electrocatalyst is in the range of 5-100 nm and porosity of porous monolith of transition-metal doped silver electrocatalyst is in the range of 10-100 m²/gm. Furthermore, the porous monolith of transition-metal doped silver electrocatalyst is obtained by anisotropic growth of doped transition metal on silver (Ag) base material. Besides, the transition metal doping into the Ag nanoparticle is said to improve oxygen adsorption-desorption and decrease the peroxide formation capacity of the silver during oxygen reduction reaction. Furthermore, the doping of transition metal on silver (Ag) nanoparticles is carried out without utilizing high temperature or energy intensive process.

According to one embodiment herein, the porous monolith of transition-metal doped silver electrocatalyst finds application as cathode catalyst in metal-air battery, Polymer Electrolyte Membrane Fuel cells (PEMFCs), Alkaline fuel cells (AFCs), and anode catalyst in water electrolysers.

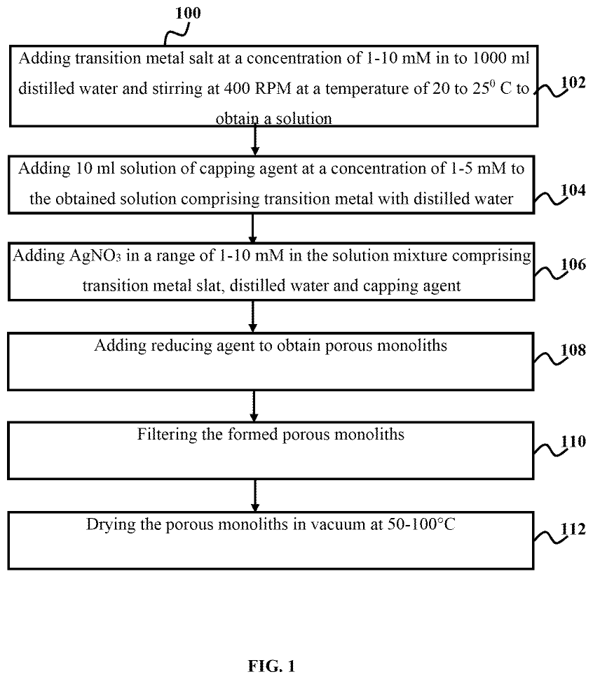

According to one embodiment herein, FIG. 1 illustrates an exemplary flow chart on one-pot method for synthesis of AgMn porous monoliths, according to an embodiment herein. FIG. 1 illustrates a flow chart 100 a one-pot method for synthesis of AgMn porous monoliths, wherein transition metal salt at a concentration of 0-10 mM is added in to 1000 ml distilled water and the solution is stirred at a speed of 400 RPM at a temperature of 20 to 25° C. to form a solution (102). Followed by 10 ml solution of capping agent at a concentration of 1-5 mM is added to the obtained solution and the solution is stirred at 400 RPM at a temperature of 20 to 25° C. (104). The capping agent is then added to the solution to stabilize the transition metal salt. Furthermore, Ag water soluble salt preferably AgNO₃ is added at a concentration of 0-10 mM to the obtained solution comprising transition metal salt and capping agent, and stirring the resultant solution at 400 RPM at a temperature of 20 to 25° C. (106). Besides, 10 ml solution of reducing agent at a concentration of 0-150 mM is added to the obtained Ag water soluble salt solution and the solution is stirred at a speed of 400 RPM at a temperature of 20 to 25° C. to form a porous monolith Ag nanoparticles (108). The porous monolith Ag nanoparticles formed are then filtered (110) and the resultant porous monolith Ag nanoparticles are dried in vacuum at 50° to 100° C. (112).

According to one embodiment herein, FIG. 1 illustrates the flow chart for the wet chemical synthesis of Transition-metal-doped-silver nanoparticles. 0-10 mM, 1000 ml water solution of Transition metal salt and their mixture is firstly prepared, into this solution capping agent selected from 2-mercapto ethanol, 1-thioglycerol, thioglycolic acid, thiolactic acid, sodium citrate and their mixture thereof are added to stabilize the transition metal cation. In this step, metal cation will form a stable complex with the capping agent anion, whose reduction potential will be higher than the oxidation potential of the reducing agent. Then, into this solution 0-10 mM of Ag water soluble salt is added followed by addition of reducing agent selected from at least one of Sodium borohydride, Sodium Hydride, Lithium Hydride, Lithium Aluminium Hydride, and Hydrazine Hydroxide and their mixture thereof. To obtain the porous structure, fast addition of the reducing agent is employed. Fast addition will increase the metal seed concentration and capping agent will ensure to keep these seeds separated from each other. This will not only enable the formation of metal seeds but will also increase the ionic strength of the solution, leading to the anisotropic mingling of formed metal nanoparticles and yield the porous Ag nanoparticles monolith. Apart from this, presence of highly active Ag metal seeds and a strong reducing agent will weakly induce reducing effect on the highly stable transition metal and capping agent complex and carry out the doping of the said transition-metal in the Ag-seed before its anisotropic agglomeration. Hence, one-pot synthesis protocol can be used to synthesize range of high purity and porous doped-noble metals.

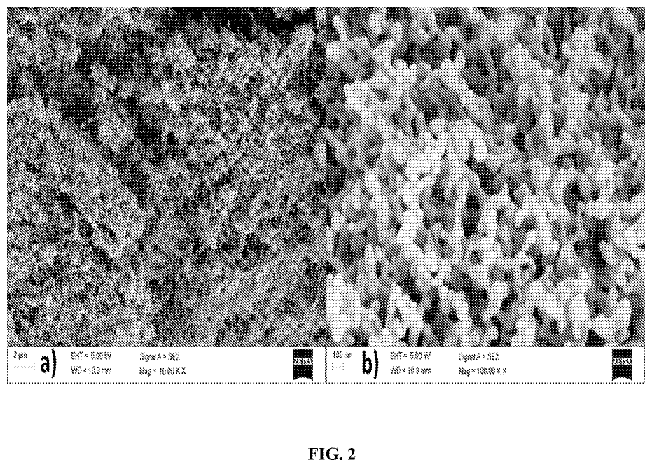

According to one embodiment herein, FIG. 2a and FIG. 2b together illustrates an exemplary Scanning electron microscope images of the porous monoliths of transition-metal-doped-noble-metal, according to an embodiment herein. SEM images to evaluate the topological and morphological features of the AgMn porous monoliths are illustrated together in FIG. 2a and FIG. 2b. FIG. 2a particularly illustrates highly porous nature of the prepared metal monoliths and FIG. 2b particularly illustrates anisotropic growth and intermingling of nanoparticles.

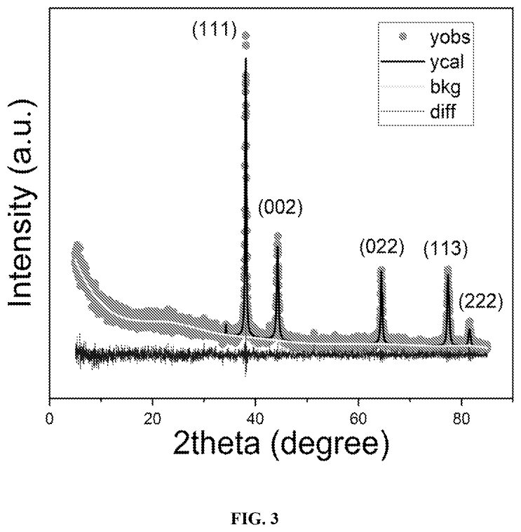

According to one embodiment herein, FIG. 3 a graph of X-Ray Diffraction analysis and its Rietveld refinement for AgMn porous monoliths, according to an embodiment herein. FIG. 3 illustrates the X-Ray Diffraction profile and Rietveld refinement of the X-Ray Diffraction peaks for the transition-metal-doped-Ag nanoparticles. Peaks fit perfectly with the Mn doped Ag nanoparticles with average particle size ranging from 40-80 nm. Absence of any other peaks for Transition metal oxide shows the efficacy of the present synthetic protocol to produce high purity porous monoliths.

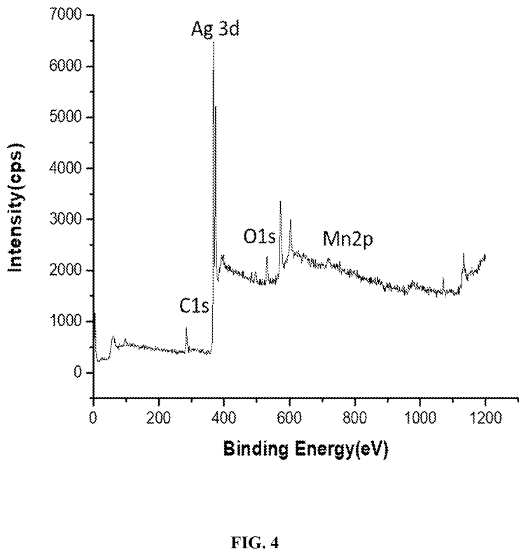

According to one embodiment herein, FIG. 4 illustrates a graphical representation of an (X-ray photoelectron spectroscopy) peak survey for AgMn porous monoliths, according to an embodiment herein. Specifically, FIG. 4 illustrates the X-Ray Photoelectron Spectroscopy peak survey of the prepared transition-metal-doped-Ag nanoparticles. Presence of transition metal, Silver and Oxide is clearly evident from the displayed graphs.

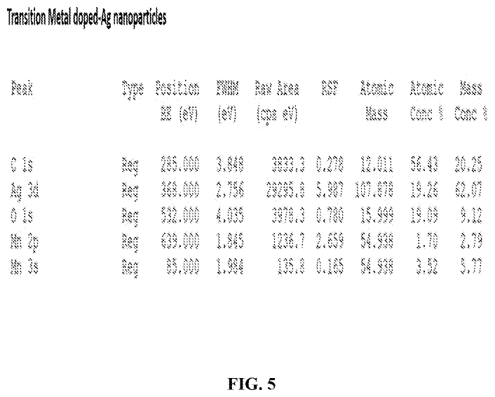

According to one embodiment herein, FIG. 5 illustrates a tabular representation of anatomic composition derived from X-Ray Photoelectron Spectroscopy for AgMn porous monoliths, according to an embodiment herein. Specifically, FIG. 5 illustrates the table, which displays the atomic concentration of each element present in the prepared transition-metal-doped-Ag. The table provides an inference that the total loading amount of transition metal in transition-metal-doped-Ag nanoparticles is only 4 to 5%.

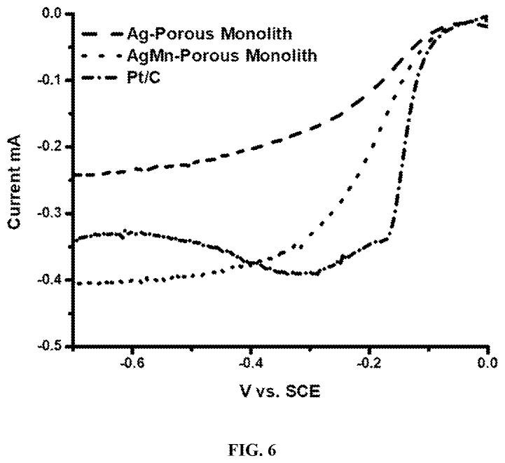

According to one embodiment herein, FIG. 6 illustrates a graphical representation of an Oxygen reduction reaction (ORR) performance of the Ag porous monolith, AgMn porous monoliths and commercial 25% Platinum loaded carbon (Pt/C) catalyst, according to an embodiment herein. FIG. 6 illustrates the Linear sweep voltammetry curves taken at 20 mV/sec scan rate, in 1M KOH saturated with O2 gas, 25° C. temperature, and 1600 RPM. Specifically, FIG. 6 shows the Linear Sweep Voltammetry curves of the prepared catalysts in presence of oxygen in 1M KOH solution at 25° C., and 1600 RPM. A clear distinction in ORR between Ag porous monolith and AgMn porous monoliths is depicted in the graph. Improvement in ORR activity in terms of current carrying capacity and onset potential, indicates the beneficial effects of transition metal doping. This can be due to the improved d-band centre of Ag due to Transition metal doping.

The embodiment herein may be more clearly understood with reference to the following examples of the invention which are given by way of example only. One has to consider that the following examples are included to demonstrate certain non-limiting aspects of the invention. It should be appreciated by those of skill in the art that the techniques disclosed in the examples which follow represent techniques discovered by the inventor to function well in the practice of the invention. However, those of skilled in the art should, in light of the present disclosure, appreciate that many changes can be made in the specific embodiments which are disclosed and still obtain a like or similar result without departing from the spirit and scope of the invention.

### Example 1

Fabrication of Air Cathode

A breathable air cathode, consisting of a current collector, catalyst layer and a backing layer, is fabricated using the AgMn based electrocatalyst. Current collector can be from, Ni-mesh, Ni-sheet, SS-sheet or SS-mesh or their combination. Onto the current collector slurry of AgMn electrocatalyst and a binder are coated on one side and onto the air side a mixture of carbon and binder is pasted. Preferably polymeric binder is a polymeric fluorinated hydrocarbon such as fluorinated ethylene, propylene, butene or mixtures thereof.

### Example 2

Prepared air cathodes (5×5 cm 2 dimensions) were then tested in a 3-electrode setup, wherein air cathodes were used as a working electrode, Standard calomel electrodes were used as a reference and platinum was used as a current collector. In the cell alkaline electrolyte consisting of 10-50 wt % of KOH/NaOH or the combination thereof and water is circulated.

### Example 3

Long Term Testing

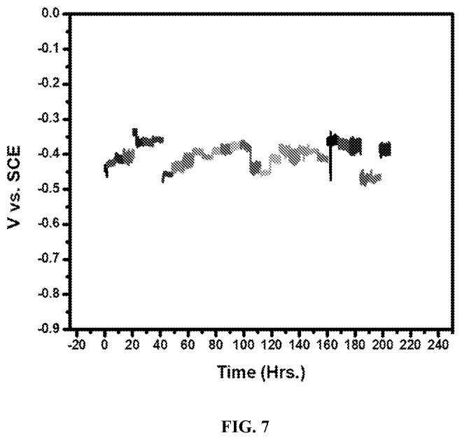

FIG. 7 illustrates the 220 hrs continues cycling test of the cathodes made up of the AgMn porous monoliths electrocatalyst, according to an embodiment herein. Specifically, FIG. 7 illustrates that the cathodes were able to withstand the given discharge current for the whole testing period in a highly alkaline medium. The dips observed in the potential are due to the replacement of the electrolytes.

According to one embodiment herein, the synthesis of porous monoliths of transition-metal-doped-noble-metal is one pot, easily scalable and obtained products are of high purity. Furthermore, transition-metal-doped-silver electrocatalyst can be used for application in Oxygen reduction reaction (ORR). The transition-metal-doped-silver electrocatalyst also exhibits better electro-catalytic activity in comparison to the virgin electrocatalysts. Moreover, the transition-metal-doped-silver electrocatalyst shows very good corrosion resistance in harsh electrochemical reaction conditions and therefore, the transition-metal-doped-silver electrocatalyst material can be used as air cathodes for applications in metal-air batteries, fuel cell and anodes for water electrolysers.

Although the embodiments herein are described with various specific embodiments, it will be obvious for a person skilled in the art to practice the embodiments herein with modifications.

The method for synthesis of porous monoliths of transition-metal-doped-noble metal disclosed in the embodiments herein have several exceptional advantages over existing techniques. Firstly, the proposed method for synthesis of porous monoliths of transition-metal-doped-silver nanoparticle provides a one-pot and scalable synthesis of high purity Ag and transition metal-doped Ag porous monoliths. Secondly, the method for synthesis of porous monoliths of transition-metal-doped-silver nanoparticle illustrates superior Oxygen reduction reaction (ORR) activity and lower peroxide formation than the virgin Ag porous monoliths. Thirdly, the method for synthesis of porous monoliths of transition-metal-doped-silver nanoparticle shows very good corrosion resistance in harsh electrochemical reaction conditions and therefore, the said material can be used as air cathodes for applications in Metal-air batteries, Fuel cell and anodes for water electrolysers. Fourthly, the method for synthesis of porous monoliths of transition-metal-doped-silver nanoparticle is a single pot, which makes the process quite facile, scalable and cost and energy effective. Furthermore, that the doping of the Ag with transition metal is realized, without using high temperature/energy intensive processes. Therefore, the proposed transition-metal-doped-silver electrocatalyst is as active as the state-of-the-art Pt/C catalyst and far more corrosion resistant in the highly alkaline condition.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A one-pot method for synthesis of porous monolith of transition-metal doped-silver electrocatalyst for oxygen reduction reaction comprising steps of:
a. adding transition metal salt at a concentration of 1-10 mM in to 1000 ml distilled water and stirring at 400 RPM at a temperature of 20 to 25° C. to form a solution;
b. adding 10 ml solution of capping agent at a concentration of 1-5 mM to the obtained solution of step (a) and stirring the solution at 400 RPM at a temperature of 20 to 25° C.; wherein the capping agent solution is added to stabilize the transition metal salt, and wherein the capping agent forms a stable bond with the transition metal salt promoting doping phenomenon;
c. adding Ag water soluble salt at a concentration of 1-10 mM to the obtained solution of step (b) and stirring the solution at 400 RPM at a temperature of 20 to 25° C.;
d. adding 10 ml solution of reducing agent at a concentration of 0-150 mM to the obtained Ag water soluble salt solution and stirring the solution at 400 RPM at a temperature of 20-25° C. to form a porous monolith Ag nanoparticles;
e. filtering the formed porous monolith Ag nanoparticles; and
f. drying the porous monolith Ag nanoparticles in vacuum at 50° to 100° C.;
wherein the porosity of porous monolith Ag nanoparticles is in the range of 10-100 m2/gm, and wherein the size of porous monolith Ag nanoparticles is in the range of 5-100 nm, and wherein the porous monolith Ag nanoparticles is configured in a circlet manner and adjoined together anisotropically to reduce surface energy and increase stability than that of individual Ag nanoparticles.

2. The one-pot method for synthesis of porous monolith of transition-metal doped-silver electrocatalyst for oxygen reduction reaction according to claim 1, wherein the capping agent is selected from the group consisting of 2-mercapto ethanol, 1-thioglycerol, thioglycolic acid, thiolactic acid, sodium citrate or their mixture thereof.

3. The one-pot method for synthesis of porous monolith of transition-metal doped-silver electrocatalyst for oxygen reduction reaction according to claim 1, wherein the Ag water soluble salt is selected from the group consisting of silver nitrate, silver fluoride, silver acetate, silver sulfate, and silver nitrite.

4. The one-pot method for synthesis of porous monolith of transition-metal doped-silver electrocatalyst for oxygen reduction reaction according to claim 1, wherein the reducing agent is selected from the group consisting of Sodium borohydride, Sodium Hydride, Lithium Hydride, Lithium Aluminium Hydride, Hydrazine Hydroxide or their mixture thereof.

5. The one-pot method for synthesis of porous monolith of transition-metal doped-silver electrocatalyst for oxygen reduction reaction according to claim 1, wherein the porous monolith Ag nanoparticles is obtained by fast addition of the reducing agent about 100 ml/min.

6. A porous monolith of transition-metal doped silver electrocatalyst for oxygen reduction reaction (ORR) comprising:
silver (Ag) nanoparticles doped with transition metals to uplift the d-band center of silver (Ag) nanoparticles and to improve catalytic activity of silver nanoparticles towards oxygen reduction reaction;
wherein the silver nanoparticles (Ag) is used as the base material doped with transition metal, and wherein the porous monolith of transition-metal doped silver electrocatalyst is obtained by anisotropic growth of doped transition metal on silver (Ag) base material, and wherein the size of porous monolith of transition-metal doped silver electrocatalyst is in the range of 5-100 nm and porosity of porous monolith of transition-metal doped silver electrocatalyst is in the range of 10-100 m2/gm, and wherein the transition metal doping is said to improve oxygen adsorption-desorption and decrease the peroxide formation capacity of the silver during oxygen reduction reaction.

7. The porous monolith of transition-metal doped silver electrocatalyst for oxygen reduction reaction (ORR) according to claim 6, wherein the transition metals is selected from the group consisting of Cobalt (Co), Copper (Cu), Nickel (Ni), Iron (Fe) and Manganese (Mn).

8. The porous monolith of transition-metal doped silver electrocatalyst for oxygen reduction reaction (ORR) according to claim 6, wherein the amount of transition metal doped into the silver (Ag) nanoparticle is the range of 1-7%.

9. The porous monolith of transition-metal doped silver electrocatalyst for oxygen reduction reaction (ORR) according to claim 6, wherein the transition metal doping is said to improve oxygen adsorption-desorption and decrease the peroxide formation capacity of the silver during oxygen reduction reaction.

10. The porous monolith of transition-metal doped silver electrocatalyst for oxygen reduction reaction (ORR) according to claim 6, wherein the porous monolith of transition-metal doped silver electrocatalyst finds application as cathode catalyst in metal-air battery, Polymer Electrolyte Membrane Fuel cells (PEMFCs), Alkaline fuel cells (AFCs), and anode catalyst in water electrolysers.
